(19) United States
(12) Patent Application Publication
(10) Pub. No.: US 2002/0145080 A1
(43) Pub. Date: Oct. 10, 2002

(54) Suction conveying system, such as a vacuum wastewater system for an aircraft

(76) Inventors: Frank Renken, Hamburg (DE); Frank Schneider, Hamburg (DE)

Correspondence Address: FASSE PATENT ATTORNEYS, P.A., P.O. BOX 726, HAMPDEN, ME, 04444-0726, US

(21) Appl. No.: 10/116,842

(22) Filed: Apr. 4, 2002

(30) Foreign Application Priority Data
Apr. 7, 2001 (DE) 101 17 623.6

(51) Int. Cl. B64D 11/00; B64D 13/00

(52) U.S. Cl. 244/118.5

(57) ABSTRACT

A vacuum wastewater system for an aircraft includes a collection pipe leading to a collection container, a branch pipe leading from a receptacle, and a Y-shaped pipe junction with an acute entry angle connecting the branch pipe into the collection pipe on a side thereof opposite from the receptacle. The branch pipe crosses over the collection pipe just upstream of the junction. An arcuate pipe bend joins a straight portion of the branch pipe to a straight branch pipe leg of the pipe junction in substantially the same horizontal plane in which the collection pipe extends. This configuration deflects the flow of conveyed material so that centrifugal force holds the material along the pipe wall away from the crotch of the Y-shaped junction. This minimizes the reverse flow against the main conveying direction and deposition and accumulation of material in the collection pipe upstream from the pipe junction.

### PRIORITY CLAIM

This application is based on and claims the priority under 35 U.S.C. §119 of German Patent Application 101 17 623.6, filed on Apr. 7, 2001, the entire disclosure of which is incorporated herein by reference.

### FIELD OF THE INVENTION

The invention relates to a suction conveying system, especially a vacuum wastewater system for an aircraft, including a receptacle such as a toilet, a collection tank, a collection pipe running to the collection tank, and a branch pipe running from the receptacle to a pipe junction at which the branch pipe is connected to the collection pipe.

### BACKGROUND INFORMATION

Conveying various materials by pneumatic suction is known in various different applications. The pneumatic suction conveying uses a reduced pressure or vacuum to transport a single-phase or multi-phase conveyed material between a receptacle, into which the material is deposited, and a collection container. The overall system for carrying out such a pneumatic suction conveying generally includes a receptacle, a branch or feeder pipe running from the receptacle, a collection pipe running to at least one collection container, and a pipe junction that joins the branch pipe to the collection pipe.

One typical example of such a system is the wastewater and waste disposal system in a commercial passenger transport aircraft. For example, German Patent Laying-Open Publication DE 198 34 537 and corresponding U.S. Pat. No. 6,330,725 disclose such a pipe system for conveying the wastewater from toilets and washbasins to a collection or holding tank. The toilets are connected by connection pipes, i.e. branch or feeder pipes, to a collection pipe that runs essentially horizontally along the passenger cabin of an aircraft. The branch pipes lead vertically downwardly from the respective receptacle, e.g. a toilet, to the collection pipe and are joined into the collection pipe by a pipe junction.

In general, such a pipe junction by which a branch pipe is joined to a collection pipe or main trunk pipe is conventionally embodied as a Y pipe junction, for example as illustrated in prior art FIG. 6 of the present application, and as discussed further below. Such a pipe junction suffers disadvantageous flow conditions. Due to the pneumatic suction conveyance of a flow of material entrained in a fluid such as water or air or a mixture thereof, one or more vortices are generated in the pipe junction. This causes a portion of the conveyed material to be conveyed in a reverse direction opposite the defined main conveying direction from the receptacle to the collection container. The reverse flow particularly flows into an eddy area or reverse flow region of the collection pipe at a point upstream of the pipe junction entry edge at which the branch pipe joins into the collection pipe. This reverse flow leads to a regular depositing and accumulating of a portion of conveyed material in this reverse flow region during each conveying cycle (e.g. toilet flushing cycle). Over time, ever more material accumulates at this location and will not be transported through the collection pipe to the collection container, but rather forms a restriction or blockage upstream of the pipe junction in the collection pipe.

The above described regular deposition and accumulation of partial quantities of the conveyed material in the collection pipe in the reverse flow region upstream from a pipe junction has a substantial disadvantageous influence on the functional availability of the suction conveying system. Particularly, this deposited and accumulating conveyed material leads to a reduced conveying capacity for subsequent conveying cycles from receptacles located farther upstream along the collection pipe, because the conveyed material from such receptacles must pass through the restricted area of the collection pipe. Especially by the conveyance veyance of multi-phase materials, such as a wastewater flow carrying various solid, semi-solid and pasty waste materials, the deposited and accumulating waste material in the described reverse flow regions leads to the formation of a durable, stable, and strongly adherent sediment accumulation upstream of the pipe junction in the collection pipe. Such sediment accumulations lead to plugging and blockages of the collection pipe, thus requiring substantial maintenance or repair efforts.

FIG. 6 of the present application shows a conventional pipe junction in the above discussed context. A connection pipe or branch pipe 3 leads from a disposal receptacle such as a toilet 2 to a main collection pipe 5, where a pipe junction 4′ connects the branch pipe 3 to the collection pipe 5. The collection pipe 5 then leads to a collection or holding tank 6. The collection pipe 5 continues in a substantially straight line past the area of the junction. Such a configuration of a pipe junction 4′ suffers a high risk of depositing and accumulation of conveyed material in the collection pipe 5 as generally discussed above. Due to the pneumatic conveying suction, the conveyed flow pattern leads to a vortex generation in the pipe junction 4′, whereby the vortices transport a portion of the conveyed material 7 in a reverse flow direction contrary to the defined main conveying direction 10 into a reverse flow region 9 of the collection pipe 5 just upstream from the junction entry edge 8′ at the crotch of the Y junction where the branch pipe 3 leads into the collection pipe 5. More particularly, the transport of conveyed material 7 in a direction contrary to the main conveying direction 10 in this manner is caused by the formation of two distinct vortices: first a separation vortex and secondly a stagnation or ram point vortex.

A separation vortex is formed along the junction entry edge 8′ of the pipe junction 4′ where the branch pipe 3 leads into the collection pipe 5 in area A shown in FIG. 6. The stream of material 7 that is conveyed by the pneumatic suction undergoes a separation from the junction entry edge 8′ of the pipe junction 4′ as it enters into the collection pipe 5. This causes a secondary flow which in turn leads to the formation of a separation vortex at this location. The portion of the conveyed material 7 that flows over the junction entry edge 8′ of the pipe junction 4′ is entrained in the generated rotating separation vortex at this location and is thereby transported contrary to the main conveying direction 10 into the reverse flow region 9 upstream of the pipe junction, where the conveyed material can then deposit and accumulate.

At the beginning of a conveying process, i.e. when the pneumatic suction is applied to convey a batch of material 7, the conveying flow velocity at this time is at a maximum, which leads to the greatest influence of the separation vortex on the transport of the conveyed material 7. On the other hand, as the conveyed flow velocity diminishes toward zero at the end of the conveying process, the separation vortex collapses upon itself. At that time, the portion of conveyed material 7 rotating in the separation vortex loses its energy, and settles out, under the influence of gravity, on the gravitationally downward pipe wall of the reverse flow region 9 of the collection pipe 5. With each new conveying cycle, additional conveyed material 7 will be deposited in the reverse flow region 9 in this manner, so that the deposited material accumulates in quantity and volume with each successive conveying cycle. The formation and subsequent collapse of this separation vortex is geometrically caused and necessitated by the configuration of the pipe junction.

The second vortex mentioned above that tends to transport conveyed material 7 in a direction contrary to the main conveying direction 10 is a stagnation or ram point vortex. This vortex arises directly at the point at which the conveyed material stream entering into the collection pipe 5 from the branch pipe 3 impinges onto the opposite inner wall of the collection pipe 5, i.e. in the area B of the pipe junction 4′ as shown in FIG. 6. This phenomenon of the stagnation point vortex can be understood by analogy to the flow condition that arises when a free flow stream of material impinges onto a perpendicular planar surface. Depending on the angle of incidence α, a relatively larger or smaller proportion of the conveyed material 7 will be deflected from the pipe wall on which it impinges, to be transported in a direction contrary to the main conveying direction 10. If the junction angle or angle of incidence α is relatively blunt, i.e. closer to 90°, then the proportion of the conveyed material 7 being transported contrary to the main conveying direction 10 is relatively large. On the other hand, as the angle of incidence α becomes smaller or sharper, then the proportion of the conveyed material 7 that will flow in a direction contrary to the main conveying direction 10 becomes correspondingly smaller. In any event, these two vortex phenomena as described above cause the deposition and accumulation of material inside the collection pipe in the area within the pipe junction.

The German Patent Publication DE 690 12 773 T2 of the European Patent EP 0,436,357 discloses a vacuum wastewater disposal system, in which waste material is conveyed to a collection tank via a horizontally extending collection pipe. Waste-receiving bowls are arranged below the sewer pipe, and waste material is introduced into the system through these bowls. FIG. 2 of this reference shows that several wastewater delivery units are connected to the main sewer pipe via corresponding branch pipes. Each branch pipe joins into the main sewer pipe by means of a pipe junction, with a pipe bend where the branch pipe joins from above into the main sewer pipe. The conveyed stream of waste material is influenced by gravity, so that a portion of the conveyed material can flow into and be influenced by the separation vortex forming along the acutely angled junction entry edge. As a result, deposits and accumulation of waste material can occur in a reverse flow region just upstream of the pipe junction in the collection pipe.

### SUMMARY OF THE INVENTION

In view of the above, it is an object of the invention to provide a suction conveying system of the above described general type, which has been improved so as to reduce the deposition and accumulation of conveyed material in the area of a pipe junction. More particularly, the invention aims to provide a configuration of a pipe junction of such a suction conveying system so as to reduce the degree to which material is conveyed in a direction contrary to the main conveying direction during the time of a conveying process, so that the deposition and accumulation of the conveyed material in the collection pipe can be reduced. It is another object of the invention to provide a wastewater disposal system for a commercial passenger transport aircraft using such a suction conveying system. The invention further aims to avoid or overcome the disadvantages of the prior art, and to achieve additional advantages, as apparent from the present specification.

The above objects have been achieved according to the invention in a suction conveying system, and especially a vacuum wastewater system of an aircraft, including a receptacle such as a toilet or a washbasin, a collection container, a branch pipe leading from the receptacle, a generally horizontally extending collection pipe that leads to the collection container, and a pipe junction that joins the branch pipe with the collection pipe. The pipe junction has a generally Y-shaped configuration with a main pipe leg interposed in the collection pipe and a branch pipe joining into the main pipe leg while forming an acutely angled junction entry edge in the crotch of the resulting Y-shape. The branch pipe crosses the collection pipe on its course from the receptacle to its junction into the collection pipe. The branch pipe or the pipe junction includes a pipe bend or elbow, and particularly a circularly arcing pipe curve that extends from a straight pipe section of the branch pipe to the straight pipe section of the branch pipe leg of the pipe junction. The pipe bend preferably is a circular bend of at least 90° between the adjoining straight pipe section of the branch pipe and the adjoining straight pipe section of the branch pipe leg. The pipe bend and the straight pipe section of the branch pipe leg of the pipe junction join into the collection pipe substantially along the same horizontal plane along which the collection pipe extends.

With the above described configuration, the pipe junction exerts an advantageous flow pattern on the conveyed flow of material through this pipe junction. Namely, the conveyed material flowing from the branch pipe through the pipe curve or pipe bend is subjected to a centrifugal force that causes the conveyed material to flow along the outer radius of curvature of the pipe bend and along the adjoining wall of the straight pipe portion (i.e. the branch pipe leg) of the pipe junction lying opposite and away from the junction entry edge formed at the crotch of the Y-shaped pipe junction. Thereby, the flow of conveyed material is directed away from the separation vortex that forms at the junction edge, so that the reverse flow of material caused by this separation vortex is reduced.

The use of such a pipe system for the wastewater being conveyed from the toilets and washbasins to a collection tank in a commercial passenger transport aircraft achieves a reduced maintenance requirement for the wastewater system. More particularly, this reduces the deposition, accumulation, and sedimentation of material in the collection pipes of the vacuum wastewater system, which run over long distances through the aircraft. This reduces time and cost intensive cleaning and maintenance processes for the pipe system, and improves the functional availability of the overall wastewater system.

The reduced reverse transport of conveyed material in a direction contrary to the main conveying direction in the inventive configuration of a pipe junction for a suction conveying system further achieves the following additional advantages. The mass proportion of the material conveyed properly in the direction toward the collection container per conveying cycle is increased. Thus the efficacy of the suction transport is increased. The system functionality and availability is increased by the above described reduction of the mass proportion of conveyed material that is deposited upstream of the pipe junction location, with an associated reduction of the deposition and encrustation of sediment materials such as solid material components of pneumatically conveyed wastewater in the collection pipe. The maintenance intervals may be increased, which in turn leads to a reduction of the maintenance costs. This further involves a reduction of the required time and cost intensive cleaning processes for cleaning the pipe system between the disposal receptacles and the collection container or containers.

### BRIEF DESCRIPTION OF THE DRAWINGS

In order that the invention may be clearly understood, it will now be described in connection with an example embodiment relating to an application in a commercial passenger transport aircraft, with reference to the accompanying drawings, wherein:

FIG. 1 is a schematic “ghost” side view of a commercial passenger transport aircraft with a schematic illustration of the installation of a suction conveying system for the wastewater of the aircraft;

FIG. 2 is an enlarged detail side view of a section of the suction conveying system in the area of a pipe junction according to the invention;

FIG. 3 is a schematic top view of the aircraft according to FIG. 1;

FIG. 4 is a schematic top view of the pipe junction shown in FIG. 2;

FIG. 5 is a schematic top view of the pipe junction according to the invention, partially sectioned open to illustrate the functioning thereof; and

FIG. 6 is a schematic illustration in the manner of FIG. 5, but showing a prior art pipe junction and its functioning.

### DETAILED DESCRIPTION OF PREFERRED EXAMPLE EMBODIMENTS AND OF THE BEST MODE OF THE INVENTION

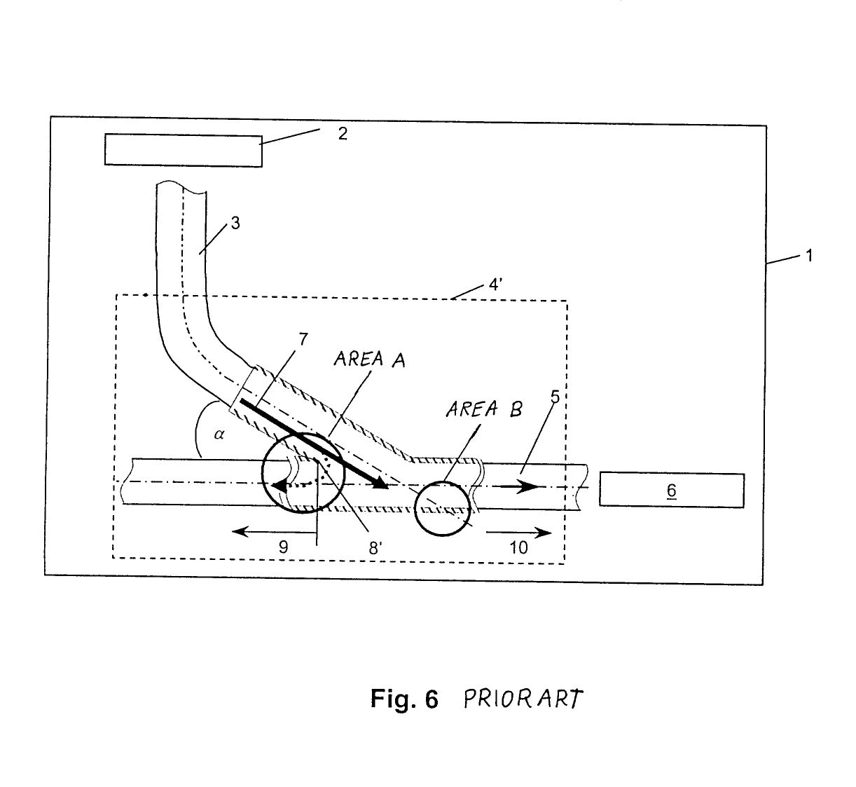

The prior art pipe junction 4′ as shown in FIG. 6, as well as the functional operation thereof, have been described above in the “Background Information” section of this application. The inventive suction conveying system according to FIGS. 1 to 5 will now be described, while focusing on the differences between the prior art system and the present inventive system.

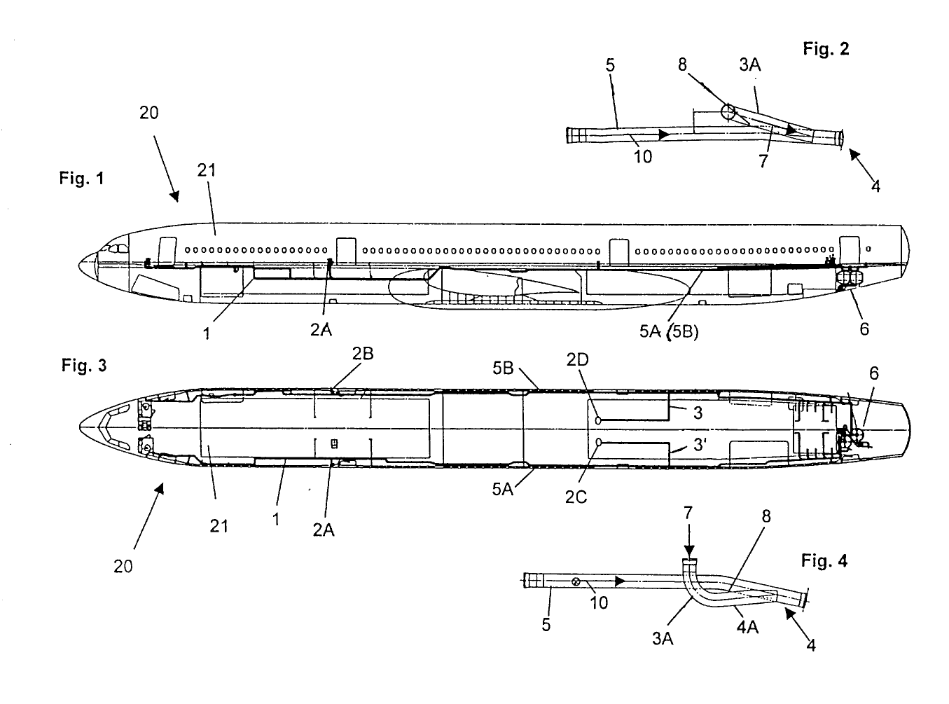

FIG. 1 schematically shows a side view of a typical commercial passenger transport aircraft 20, while FIG. 3 shows the corresponding top view thereof. These views show the overall installation of a wastewater system 1 as a particular example of the present suction conveyor system 1. FIGS. 2 and 4 respectively show a side view and a top view of a pipe junction 4 according to the invention, as a detail portion of the overall wastewater system 1.

The aircraft 20 includes a passenger cabin 21, which is provided and equipped for the comfortable transport of air passengers. Several toilets 2A, 2B, 2C and 2D are spatially distributed throughout the passenger cabin 21, and are all connected to the central wastewater system 1. This wastewater system 1 functions as a suction conveyor system, which conveys the waste by means of a vacuum or applied suction. Additional waste receptacles such as washbasins, galley sinks, urinals, showers, or the like may also be connected to the wastewater system 1. The details of the various vacuum valves, flush valves, suction generators and the like that are used to generate and control the required conveying suction, and particularly to carry out a waste conveying process, e.g. flushing a toilet and conveying the contents of the toilet through the wastewater system 1 to the collection tank 6, are not shown or described in detail. These components can be embodied according to any conventionally known teachings relating to suction conveyor systems.

The toilets 2A to 2D, as an example of the disposal receptacles 2 for the material to be conveyed, are connected by connection pipes or branch pipes 3 and 3′ to a collection pipe 5 that runs essentially horizontally. A pipe such as the collection pipe 5 is said to run or extend “essentially horizontally” when it extends generally parallel to the longitudinal axis of the aircraft in the present example embodiment. Thus, the term “substantially horizontal” does not require a perfectly horizontal orientation, but rather is intended to distinguish from pipe orientations that would be understood to be substantially vertical, and in any event, allows for a range, e.g. ±10° around horizontal. Also, throughout this application, the term “pipe” is intended to include any pipe, hose, duct, conduit or the like, which is suitable for conveying a material by suction enclosed therein.

The collection pipe 5 runs in the longitudinal direction nearly entirely (e.g. at least 90%) along the longitudinal length of the entire passenger cabin 21, and particularly below the floor of the passenger cabin. In the present example embodiment, there are two collection pipes 5A and 5B, whereby the first collection pipe 5A runs longitudinally along the left side of the aircraft, while the second collection pipe 5B runs longitudinally along the right side of the aircraft. The branch pipes 3 and 3′ include a pipe section that leads vertically downward from the respective toilet to the area below the passenger cabin 21 in a direction toward the collection pipes 5A or 5B, as well as a nearly horizontal inlet portion with only a slight slope angle in the last part of the branch pipe leading to the collection pipe (see FIG. 2 for example). At this location, the branch pipes 3 and 3′ lead through a pipe elbow or bend 3A into the pipe junction 4, which respectively carries out the actual joining of the branch pipes 3 and 3′ to the collection pipes 5A and 5B. The collection pipes 5A and 5B then lead further to collection or holding tanks 6 for receiving the wastewater.

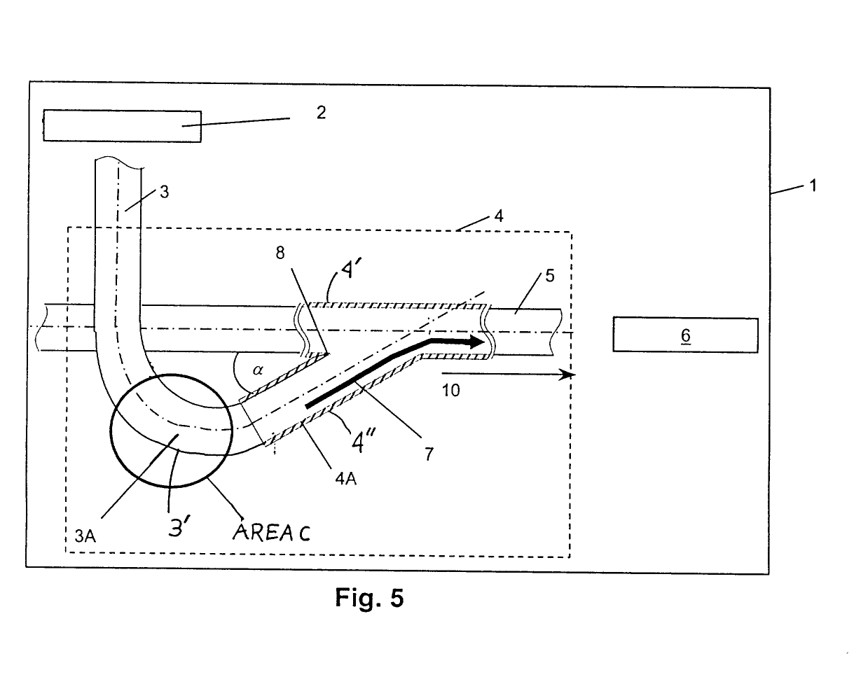

As can be understood from FIGS. 3 and 4, and as discussed in greater detail below in connection with FIG. 5, the connection the branch pipes 3 and 3′ through the respective pipe elbow or bend 3A into the collection pipes 5A and 5B is respectively on the side of the collection pipe 5A or 5B opposite the location of the respective toilet or other receptacle. In other words, as seen in the flow direction from the respective receptacle 2, the respective branch pipe 3 or 3′ crosses over the continuous extension of the collection pipe 5A or 5B in order to then be joined into the collection pipe 5A or 5B on the opposite side thereof. This relates to the arrangement of the respective pipe bends 3A, and achieves an advantageous deflection and centrifugal directing of the flow of the conveyed material 7 as will be discussed below.

In order to transport or convey the conveyed material 7 (e.g. waste material from the toilets 2) as shown schematically by the arrow 7, a negative pressure or vacuum is generated in the collection container 6, the collection pipe 5, the pipe junction 4, and the branch pipe 3, such that the conveyed material 7 is transported by suction in a main conveying direction 10. The details of the flow or conveyance of the conveyed material 7 through the inventive pipe junction 4 will be shown and described below in connection with FIG. 5.

As has been discussed above, the conventional pipe junction 4′ according to the prior art as shown in FIG. 6, suffers a disadvantageous flow pattern of the conveyed material 7. The formation of a separation vortex along the junction entry edge 8′ (area A) and of a stagnation vortex on the opposite inner wall (area B) of the collection pipe 5 cause a partial reverse flow of the conveyed material 7 into a reverse flow region 9 upstream of the pipe junction in the collection pipe 5. The inventive configuration of the pipe junction 4 minimizes these disadvantageous flow patterns.

In general, with respect to the flow-directed configuration of the inventive pipe junction 4, the actual connection of the junction end of the branch pipe 3 into the collection pipe 5 is located on the side of the collection pipe 5 opposite the receptacle, e.g. the toilet 2A to 2D connected to the opposite end of this branch pipe 3. Thus, the branch pipe 3 crosses the main extending trunk of the collection pipe 5 immediately before joining the pipe junction 4. The junction end of the branch pipe 3 has a pipe elbow or bend 3A so as to purposely deflect the flow of conveyed material 7, so that it is influenced by the centrifugal force to flow along the outer radius of curvature of this pipe bend 3A. From there, the conveyed material 7 continues to flow through a straight portion of the pipe junction 4 along the inner surface of the pipe wall thereof that is located opposite the junction entry edge 8 formed in the crotch of the Y-shaped pipe junction. Thereby, the amount or portion of the conveyed material 7 that flows directly along and past the junction entry edge 8 is reduced or eliminated, which thereby minimizes the proportion of conveyed material 7 that will become entrained in the rotating separation vortex that forms along the junction entry edge 8. The overall result is a substantially reduced amount of conveyed material 7 that is caused to flow in a direction contrary to the main conveying direction 10 in the collection pipe 5A or 5B.

More particularly, FIG. 5 shows a top plan schematic view of the inventive pipe junction 4 to illustrate the functional operation thereof within the overall suction conveying system 1. This embodiment combines the advantages of a relatively sharp entry angle α with the beneficial inventive configuration that has been generally discussed above. Preferably, the Y-shaped pipe junction 4 includes a straight main pipe leg 4′ and a straight branch pipe leg 4″ joined to each other in a Y-shape, forming the inlet angle α in the Y-shaped crotch therebetween. This inlet angle α is preferably smaller than 30°. The pipe junction 4 is preferably formed of rotationally symmetrical and/or elliptical pipe components, i.e. the main pipe leg and the side pipe leg are each circular or elliptical in cross-section.

In the flow-directed configuration of the pipe junction 4, the actual inlet of the branch pipe 3 into the collection pipe 5 is located on the side of the collection pipe 5 opposite the respective receptacle or toilet 2. Thus, the branch pipe 3 crosses over the straight extension of the main collection pipe 5 just before connecting to the pipe junction 4. The end of the branch pipe 3 (or equivalently the end of the branch pipe leg 4″ of the pipe junction 4, or a separate interposed pipe component) is provided with a pipe elbow or bend 3A in the area C shown in FIG. 5. This pipe bend 3A is preferably a circular arcing pipe bend 3A with a bend angle of at least 90° between the adjoining straight portion of the branch pipe 3 and the adjoining straight branch pipe leg 4″ of the pipe junction 4.

In the illustrated embodiment of FIG. 5, the pipe bend 3A has a curvature of about 120°, so that the straight portion of the adjoining branch pipe 3 crosses over the main extension of the collection pipe 5 at a right angle, in connection with the inlet angle α being 30°.

Also preferably, the straight branch pipe leg 4″ of the pipe junction 4 joins directly to the circularly arcing pipe bend 3A, which in turn joins directly to the straight portion of the branch pipe 3 that crosses over the main extension of the collection pipe 5. The branch pipe leg 4″ and the pipe bend 3A extend along a plane that slopes slightly upward at a small acute angle, e.g. an angle less than 20°, toward the branch pipe 3 which crosses above the collection pipe 5.

With the above described configuration, the curving pipe bend 3A causes a purposeful flow deflection of the conveyed material 7, so that the arising centrifugal force causes the conveyed material 7 to flow along the outer radius of curvature 3′ of the pipe bend 3A in the area C. From there, the conveyed material 7 continues to flow into the straight branch pipe leg 4″ of the pipe junction 4 and from there into the collection pipe 5. Thereby, the conveyed material 7 particularly flows along the inner surface of the pipe wall 4A opposite the junction entry edge 8. This keeps the conveyed material 7 away from the area in which a separation vortex forms, and also introduces the conveyed material 7 into the collection pipe 5 at a point far downstream from the entry edge 8 and the area of the junction of the two legs 4′ and 4″. Thereby, the proportion of the conveyed material 7 that flows in a reverse direction into a reverse flow region upstream of the junction entry edge 8 is minimized or totally avoided, because less material will be entrained in the rotating separation vortex that forms along the junction entry edge 8, and less material will be forced backwards from a stagnation vortex at the point at which the flow of conveyed material is introduced into the main collection pipe 5.

Throughout this specification, the terms “upstream” and “downstream” are to be understood with reference to the normal conveying direction 10 of the conveyed material 7 through the pipe system.

Although the invention has been described with reference to specific example embodiments, it will be appreciated that it is intended to cover all modifications and equivalents within the scope of the appended claims. It should also be understood that the present disclosure includes all possible combinations of any individual features recited in any of the appended claims.

What is claimed is:

1. A suction conveying system for conveying a conveyed material from a receptacle to a collection container, comprising:
a receptacle;
a collection container;
a collection pipe that extends substantially horizontally and is connected to said collection container;
a pipe bend;
a branch pipe having a first end connected to said receptacle and a second end joining said pipe bend; and
a pipe junction interposed between and joining together said pipe bend and said collection pipe;
wherein:
said pipe junction includes a main pipe leg and a branch pipe leg joined to said main pipe leg to form an acute junction angle therebetween, with an acute junction entry edge formed where said branch pipe leg joins said main pipe leg;
said collection pipe includes an upstream pipe section and a downstream pipe section, and said main pipe leg of said pipe junction is interposed and joined between said upstream pipe section and said downstream pipe section; and
said branch pipe leg of said pipe junction and said receptacle are respectively located on opposite sides of said collection pipe.

2. The suction conveying system according to claim 1, wherein said pipe bend and said branch pipe leg of said pipe junction extend along a common substantially horizontal plane.

3. The suction conveying system according to claim 1, wherein said pipe bend and said pipe junction have such a configuration so that a flow of the conveyed material from said branch pipe is deflected in said pipe bend in such a manner that centrifugal force causes the conveyed material to flow along an outer radius of curvature within said pipe bend and then along a pipe wall of said branch pipe leg lying opposite and away from said junction entry edge.

4. The suction conveying system according to claim 3, wherein said pipe junction further has such a configuration so that a separation vortex is generated along said junction entry edge in said pipe junction.

5. The suction conveying system according to claim 1, wherein said pipe bend and said branch pipe leg of said pipe junction slope downwardly at a small acute angle from a point adjoining said branch pipe above said collection pipe to a side of said collection pipe where said branch pipe leg joins into said main pipe leg of said pipe junction.

6. The suction conveying system according to claim 1, wherein said acute junction angle is smaller than 30°.

7. The suction conveying system according to claim 1, wherein said main pipe leg and said branch pipe leg each respectively have a circular, rotationally symmetrical, or elliptical cross-sectional shape.

8. The suction conveying system according to claim 1, wherein said pipe bend has a circular segment arc shape.

9. The suction conveying system according to claim 1, wherein said pipe bend has a bend angle of 90°.

10. The suction conveying system according to claim 1, wherein said pipe bend has a bend angle of at least 90°.

11. The suction conveying system according to claim 1, wherein said pipe bend has a bend angle of 110° to 130°.

12. The suction conveying system according to claim 1, wherein said pipe bend crosses over said upstream pipe portion of said collection pipe or said main pipe leg of said pipe junction.

13. The suction conveying system according to claim 12, wherein said branch pipe comprises a straight pipe section, said pipe bend directly adjoins said straight pipe section of said branch pipe and directly adjoins said branch pipe leg of said pipe junction, and said branch pipe leg extends straight into said main pipe leg of said pipe junction.

14. The suction conveying system according to claim 1, wherein said branch pipe comprises a straight pipe portion that extends substantially horizontally and crosses over said upstream pipe portion of said collection pipe or said main pipe leg of said pipe junction.

15. The suction conveying system according to claim 14, wherein said pipe bend directly adjoins said straight pipe portion of said branch pipe and directly adjoins said branch pipe leg of said pipe junction, and said branch pipe leg extends straight into said main pipe leg of said pipe junction.

16. The suction conveying system according to claim 1, wherein said pipe bend or said branch pipe crosses over said upstream pipe portion of said collection pipe or said main pipe leg of said pipe junction at a crossing angle of 90°.

17. The suction conveying system according to claim 1, wherein said branch pipe comprises a first pipe portion extending substantially vertically downwardly from said receptacle, and a second pipe portion extending substantially horizontally and crossing over said upstream pipe portion of said collection pipe or said main pipe leg of said pipe junction.

18. The suction conveying system according to claim 1, wherein said suction conveying system is a vacuum wastewater system of a passenger transport aircraft having a passenger cabin above a cabin floor level, wherein said collection pipe extends substantially horizontally below the cabin floor level along nearly an entire longitudinal length of said passenger cabin, and wherein said receptacle is located above said collection pipe.

19. The suction conveying system according to claim 18, wherein said receptacle is an aircraft toilet.
